(19) United States
(12) Patent Application Publication
(10) Pub. No.: US 2003/0034886 A1
(43) Pub. Date: Feb. 20, 2003

(54) Emergency light device

(76) Inventor: Zhi-Cong Liu, Shalu Jen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/930,459

(22) Filed: Aug. 16, 2001

(51) Int. Cl. G08B 19/00

(52) U.S. Cl. 340/521; 340/628; 340/690

(57) ABSTRACT

An emergency light device includes a casing having a circuit board which includes a light circuit and a detection circuit. The light circuit has an re-chargeable circuit and a starting circuit which is connected to a bulb so that the bulb lights up when the electric power is out. The detection circuit has a control IC, vibration sensor, a smoke detection device and a siren. The siren horns and the bulb lights up when the vibration sensor or the siren smoke detection device are activated.

### FIELD OF THE INVENTION

The present invention relates to a multiple function emergency light device that includes a vibration sensor which activates a siren and a bulb to provide warning signal and light for convenience of escape.

### BACKGROUND OF THE INVENTION

Several severe earth quakes happened within the past few years and cause a tremendous property lost and grab a lot of people's life. Most people a are hurt or even died during earth quakes partly because there have no proper warning signals. Although the modern knowledge cannot detect earth quake precisely, if people have an emergency light device in their homes and the emergency light device is properly activated when a small scale of vibration happens, at least the damage caused directly by the earth quake can be reduced.

### SUMMARY OF THE INVENTION

In accordance with one aspect of the present invention, there is provided an emergency light device which comprises a casing having a circuit board which includes a light circuit and a detection circuit. The light circuit has a re-chargeable circuit and a starting circuit which is connected to a bulb. The detection circuit has a control IC, a vibration sensor and a siren. The vibration sensor and the siren are controlled by the control IC. The control IC is connected to the re-chargeable circuit in the bulb.

The primary object of the present invention is to provide an emergency light device that provides siren signals and light when the device detects vibration or smoke.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the emergency light device of the present invention;

FIG. 2 is a perspective view to show the emergency light device of the present invention;

FIG. 3 is an illustrative view to show the light circuit of the emergency light device of the present invention;

FIG. 4 is a circuit drawing to show the light circuit of the emergency light device of the present invention, and

FIG. 5 is a circuit drawing to show the circuit of the vibration detection device of the emergency light device of the present invention.

### DETAILED DESCRIPTION OF THE PREFERRED EMBODIMENT

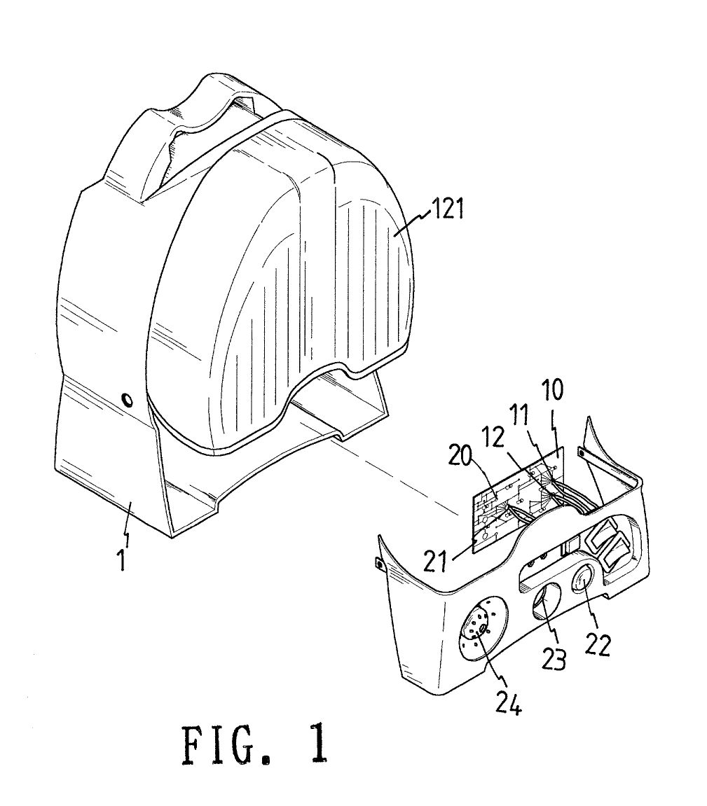

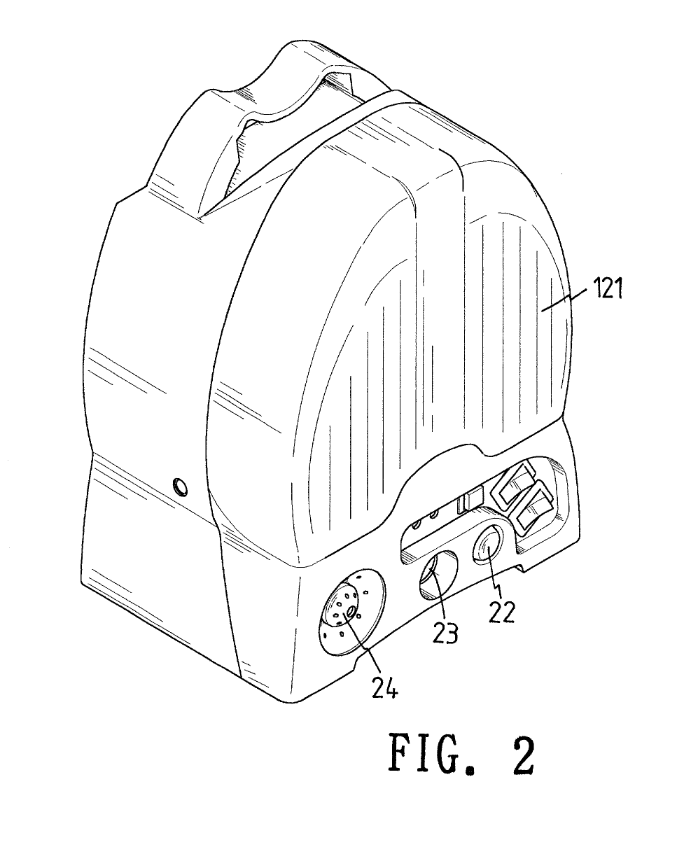

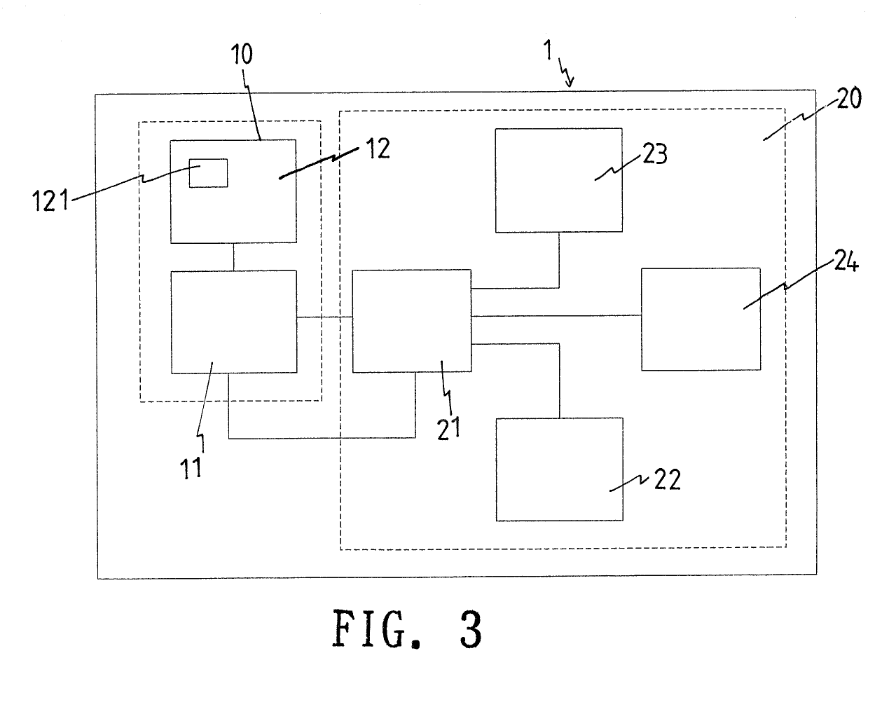

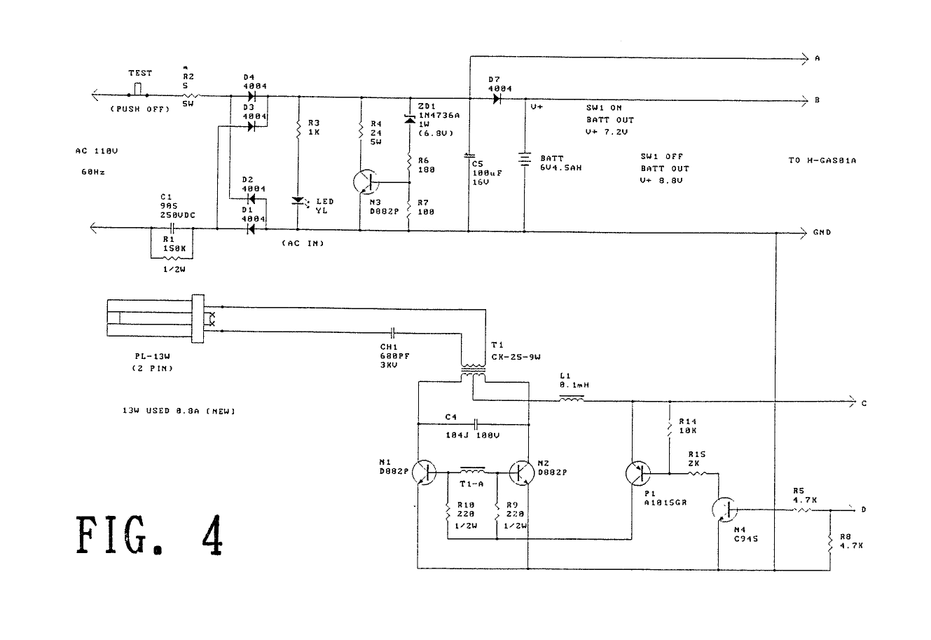

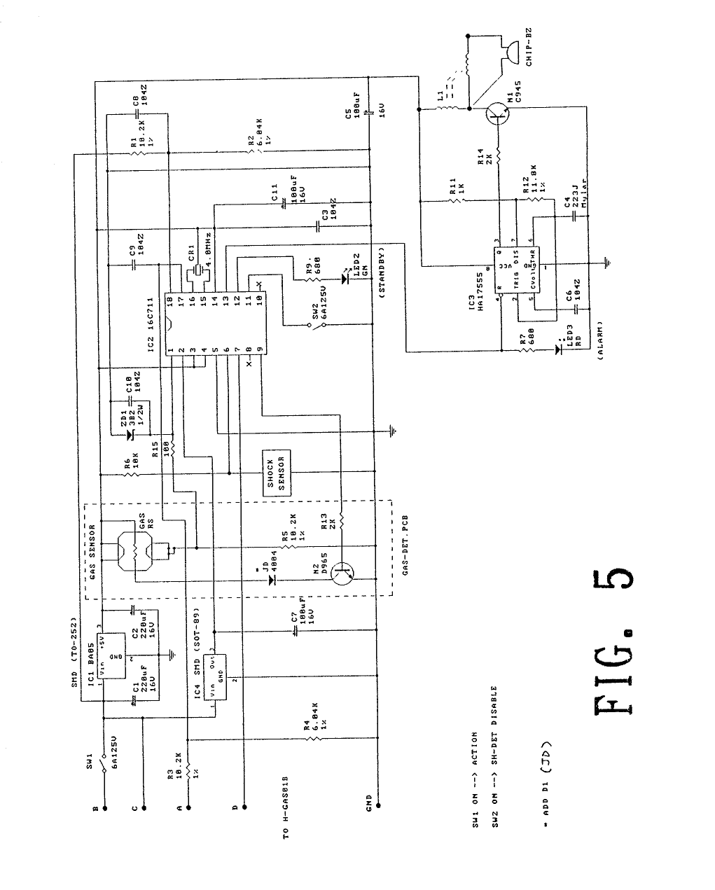

Referring to FIGS. 1 to 5, the emergency light device of the present invention comprises a casing 1 having a circuit board which includes a light circuit 10 and a detection circuit 20 received therein. The light circuit 10 has a re-chargeable circuit 11 and a starting circuit 12 which is connected to a bulb 121. The re-chargeable circuit 11 provides electric power to the bulb 121 when in emergency. The detection circuit 20 has a control IC 21, a vibration sensor 23, a smoke detection device 22 and a siren 24. The vibration sensor 23, the smoke detection device 22 and the siren 24 are controlled by the control IC 21. The control IC 21 is connected to the re-chargeable circuit 11 in the bulb 121.

When the vibration detection device 23 detects a vibration higher than a pre-set value, it sends a signal to the control IC 21 which confirms the signal and activates the light circuit 10 to let the bulb 121 lights up for two minutes, and the siren 24 is activated for two minutes to provide warning signals to the people.

When the smoke detection device 22 detects smoke, it sends a signal to the control IC 21 which confirms the signal and activates the light circuit 10 to let the bulb 121 lights up and the siren 24 is activated for three minutes to provide warning signals to the people.

The emergency light device of the present invention provides multiple functions and warning signals come out for few minutes such that people are warned clearly before it is too late.

While we have shown and described the embodiment in accordance with the present invention, it should be clear to those skilled in the art that further embodiments may be made without departing from the scope of the present invention.

What is claimed is:

1. An emergency light device comprising:
a casing having a circuit board which includes a light circuit and a detection circuit, said light circuit having an re-chargeable circuit and a starting circuit which is connected to a bulb, said detection circuit having a control IC, a vibration sensor and a siren, said vibration sensor and said siren controlled by said control IC, said control IC connected to said re-chargeable circuit in said bulb.

2. The device as claimed in claim 1 further comprising a smoke detection device connected to said detection circuit.
